(19) United States
(12) Patent Application Publication
(10) Pub. No.: US 2023/0264298 A1
(43) Pub. Date: Aug. 24, 2023

(54) METHOD OF PROCESSING TRANSPARENT MEMBER

(71) Applicant: AGC Inc., Tokyo (JP)

(72) Inventors: Takashige ISO, Tokyo (JP); Seiji OIKAWA, Tokyo (JP)

(73) Assignee: AGC Inc., Tokyo (JP)

(21) Appl. No.: 18/307,052

(22) Filed: Apr. 26, 2023

Related U.S. Application Data
(63) Continuation of application No. PCT/JP2021/040232, filed on Nov. 1, 2021.

(30) Foreign Application Priority Data
Nov. 13, 2020 (JP) 2020-189672

(51) Int. Cl. B23K 26/53; B23K 26/082; B23K 26/06

(52) U.S. Cl. CPC B23K 26/53; B23K 26/0643; B23K 26/082; B23K 2103/54

(57) ABSTRACT

A method of processing a transparent member, the transparent member having a first surface extending perpendicularly to the direction of laser light emission, and a second surface and a third surface that are connected to the first surface, the method including emitting laser light in the direction perpendicular to the first surface, and scanning the laser light in the direction parallel to the first surface, wherein the second surface of the transparent member is an inclined surface, or an inclined surface is disposed on the same side of the transparent member as the second surface, and, by causing the laser light to reflect on the inclined surface toward the third surface, a modified region is formed in a region having up to 2 mm depth from the third surface from the first surface to the lower end of the third surface in the direction of laser light emission.

### CROSS-REFERENCE TO RELATED APPLICATION

The present application is a continuation application filed under 35 U.S.C. 111 (a) claiming benefit under 35 U.S.C. 120 and 365 (c) of PCT International Application No. PCT/JP2021/040232 filed on Nov. 1, 2021 and designating the U.S., which claims priority to Japanese Patent Application No. 2020-189672 Nov. 13, 2020. The entire contents of the foregoing applications are incorporated herein by reference.

### BACKGROUND OF THE INVENTION

### 1. Field of the Invention

The present invention relates to a method of processing a transparent member.

### 2. Description of the Related Art

A method is known in the art by which a glass substrate is cut and separated with ultrashort pulse laser light to form a cut piece (for example, Japanese Patent Application Laid-Open No. 2016-520501).

When a transparent member is irradiated with ultrashort-pulse laser light, a modified portion is formed inside the transparent member along the direction of laser light emission. A modified surface including a plurality of modified portions can be formed by scanning the laser light. A piece targeted for cutting can be separated by cutting the transparent member along the modified surface.

When an article is formed (cleaved) from a transparent member using conventional methods, there can often be a problem in that the article is not cleaved at the intended location. In particular, at the end surface of the article, there is a high tendency that the cleaving position deviates from the target position, and in this case, there is a possibility that an article having a desired shape cannot be obtained.

### SUMMARY OF THE INVENTION

According to the present disclosure, a method of processing a transparent member, the transparent member having a first surface extending perpendicularly to the direction of laser light emission, and a second surface and a third surface that are connected to the first surface, the method including emitting laser light in the direction perpendicular to the first surface, and scanning the laser light in the direction parallel to the first surface, wherein the second surface of the transparent member is an inclined surface, or a inclined surface is disposed on the same side of the transparent member as the second surface, and, by causing the laser light to reflect on the inclined surface toward the third surface of the transparent member, a modified region is formed in a region having up to 2 mm depth from the third surface of the transparent member, from the first surface to the lower end of the third surface in the direction of laser light emission, is provided.

Further, according to the present disclosure, a method of processing a transparent member, the transparent member having a first surface extending perpendicularly to the direction of laser light emission, and a first side surface and a second side surface that are connected to the first surface, wherein a reflection member is provided on the same side of the transparent member as the first side surface to face or contact thereto, the method including: (1) emitting laser light having a predetermined focal depth in the direction perpendicular to the first surface, and scanning the laser light in the direction parallel to the first surface, wherein the focal depth is set at a depth farther than the lower end of the second side surface from the first surface in the direction of laser light emission, and the laser light is reflected on the reflection member to enter the first side surface, wherein the emitting and the scanning are both performed at least twice with different focal depths, so that a first modified region is formed, in emitting and scanning of first laser light, from the first surface to the lower end of the second side surface in the direction of first laser light emission, and a second modified region is formed, in emitting and scanning of second laser light, from the first surface to the lower end of the second side surface in the direction of second laser light emission, and wherein the first modified region or the second modified region is formed in a region having up to 2 mm depth from the second side surface; and (2) processing the transparent member by applying an external force along a plane including the first modified region and the second modified region, is provided.

Furthermore, according to the present disclosure, a method of processing a transparent member, the transparent member having a first surface extending perpendicularly to the direction of laser light emission, and a second surface and third surface that are connected to the first surface, and the second surface being an inclined surface, the method including: (1) emitting laser light having a predetermined focal depth in the direction perpendicular to the first surface, and scanning the laser light in the direction parallel to the first surface, wherein the focal depth is set at a depth between the first surface and the lower end of the third surface in the direction of laser light emission, the laser light is reflected on the second surface, wherein the emitting and the scanning are both performed at least twice with different focal depths, so that a first modified region is formed, in emitting and scanning of first laser light, from the second surface to the third surface in a scanning direction of first laser light, and a second modified region is formed, in emitting and scanning of second laser light, in a region having up to 2 mm depth form the third surface, from the first surface to the lower end of the third surface in the direction of second laser light emission; and (2) processing the transparent member by applying an external force along a plane including the first modified region and the second modified region, is provided.

### BRIEF DESCRIPTION OF THE DRAWINGS

FIG. 1 is a schematic diagram explaining a problem in separating an article from a transparent member by a conventional method;

FIG. 2 is a perspective diagram schematically illustrating the shape of a transparent member that can be used in a method according to one embodiment of the present disclosure;

FIG. 3 is a diagram schematically illustrating a flow of the method of processing the transparent member according to one embodiment of the present disclosure;

FIG. 4 is a diagram schematically illustrating a step of the method according to one embodiment of the present disclosure;

FIG. 5 is a diagram schematically illustrating the step of the method according to one embodiment of the present disclosure;

FIG. 6 is a diagram schematically illustrating the step of the method according to one embodiment of the present disclosure;

FIG. 7 is a perspective diagram schematically illustrating the shape of a transparent member that can be used in the method according to another embodiment of the present disclosure;

FIG. 8 is a diagram schematically illustrating a flow of the method of processing the transparent member according to the another embodiment of the present disclosure;

FIG. 9 is a diagram schematically illustrating a step of the method according to the another embodiment of the present disclosure;

FIG. 10 is a diagram schematically illustrating the step of the method according to the another embodiment of the present disclosure;

FIG. 11 is a diagram schematically illustrating the step of the method according to the another embodiment of the present disclosure;

FIG. 12 is a view schematically illustrating an example of an aspect of a modified region formed inside the transparent member by the method according to the another embodiment of the present disclosure; and

FIG. 13 is a photograph showing an example of a cut-face of a glass member obtained by the method according to one embodiment of the present disclosure.

### DETAILED DESCRIPTION OF THE PREFERRED EMBODIMENTS

The present disclosure has been made in view of the above-described problem, and has an object to provide a method of processing a transparent member with higher accuracy.

According to the present disclosure, a method of processing a transparent member with higher accuracy can be provided.

Hereinafter, one embodiment of the present disclosure will be described with reference to the drawings.

As described above, in the conventional method, when the article is cleaved from the transparent member, there is often a problem that the article is not cleaved at the target position. In particular, at the end surface of the article, there is a high tendency that the cleaving position deviates from the target position, and in this case, there is a possibility that an article having a desired shape cannot be obtained.

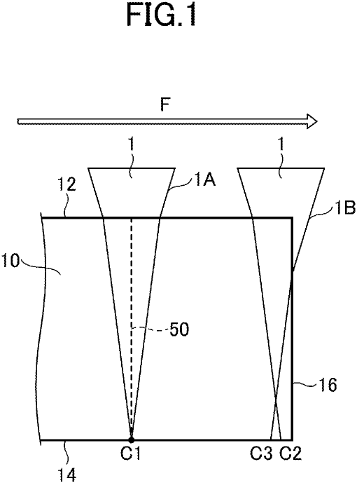

The cause of such a problem will be discussed with reference to FIG. 1.

FIG. 1 schematically illustrates a step of cleaving a transparent member by a conventional method.

As shown in FIG. 1, in this method, a transparent member 10 is processed by using ultrashort pulse laser light 1. The transparent member 10 has an upper surface 12, a lower surface 14 and a side surface 16. At the time of cleaving, the laser light 1 is vertically emitted from the upper surface 12 side of the transparent member 10. The laser light 1 is then scanned over the upper surface 12 in an arrow F direction.

When the laser light 1 is at the left position in FIG. 1, a light flux 1A of the laser light 1 is focused at a point C1 on the lower surface 14 of the transparent member 10. In the transparent member 10, a modified portion 50 is formed from the upper surface 12 to the lower surface 14 so as to pass through the point C1.

In FIG. 1, the modified portion 50 is illustrated in a linear shape, however, in practice, the modified portion 50 is formed as a region having a certain width in the scanning direction F. A modified surface including a plurality of modified portions 50 is then formed by scanning the laser light 1 in the F direction.

When the laser light 1 is at the right position in FIG. 1, a light flux 1B of the laser light 1 cannot be focused on the lower surface 14 of the transparent member 10. This is because, at this position, the right end side of the light flux 1B of the laser light 1 is made incident on the side surface 16 instead of the upper surface 12, and as a result, the right end of the light flux 1B is focused at a point C3 that is different from a point C2 where the left end of the light flux 1B is focused.

Due to such a phenomenon, it is difficult to form an appropriate modified portion from the upper surface 12 to the lower surface 14 when the light is made incident on the side surface 16 of the transparent member 10. The same phenomenon occurs when the light is made incident on the other side surface (not shown) opposite to the side surface 16 of the transparent member 10.

As a result, after emitting the laser light 1, the transparent member 10 having an inappropriately modified portion on the side surface 16 side is obtained. When such a transparent member 10 is cut along the modified surface, separation along a desired position cannot be performed at the end surfaces (such as side surface 16).

As described above, it may be difficult to obtain an article having a desired shape by the conventional method, and in particular, such a problem becomes even more noticeable when the transparent member is thick.

In contrast, according to one embodiment of the present disclosure, there is provided a method of processing a transparent member, the transparent member having a first surface extending perpendicularly to a direction of laser light emission, and a second surface and a third surface that are connected to the first surface, the method including emitting laser light in the direction perpendicular to the first surface, and scanning the laser light in the direction parallel to the first surface, wherein the second surface of the transparent member is an inclined surface, or a inclined surface is disposed on the same side of the transparent member as the second surface, and, by causing the laser light to reflect on the inclined surface toward the third surface, a modified region is formed in a region having up to 2 mm depth from the third surface, from the first surface to the lower end of the third surface in the direction of laser light emission.

In one embodiment of the present disclosure, an inclined surface is disposed on the same side of the transparent member as the second surface. The inclined surface may be provided by a member different from the transparent member. Alternatively, the inclined surface may be the second surface of the transparent member itself.

In one embodiment of the present disclosure, the laser light incident on the transparent member in the direction perpendicular to the first surface is reflected on the inclined surface. The reflected laser light propagates inside the transparent member toward the third surface.

By adjusting the focal depth of the laser light, a modified region extending from the first surface to the lower end of the third surface in the direction of laser light emission can be formed in the vicinity of the third surface of the transparent member, when the laser light is scanned in the direction parallel to the first surface. Specifically, a modified region extending from the first surface to the lower end of the third surface can be formed in a region having up to 2 mm depth from the third surface.

Here, “forming a modified region in a region having up to 2 mm depth from a target surface” refers to that the end of the modified region closer to the target surface is present in the region having up to 2 mm depth from the target surface. That is, the expression “forming a modified region in a region having up to 2 mm depth from a surface” does not necessarily mean that the modified region is formed in the entire region having up to 2 mm depth from the target surface. In general, the end of the modified region farther from the target surface of the modified region often cannot be accurately determined because of overlapping with the modified region generated by emitting another laser light.

In the present application, hereinafter, a modified region in which the end of the modified region closer to a target surface is present in a region having up to 2 mm depth from the target surface is also referred to as an “end face modified region”.

The end of the modified region closer to the target surface is preferably on the target surface (i.e. at 0 depth).

The “lower end” of the third surface refers to the end of the third surface on the opposite side to the first surface. For example, in the case of the transparent member 10 shown in FIG. 1, the “lower end” of the side surface 16 corresponds to the position at which the side surface 16 contacts the lower surface 14.

In addition, the term “perpendicular” used with respect to the direction of laser light emission includes not only a case where the angle formed between the direction of laser light emission and the surface to be irradiated is strictly 90° but also a case where the formed angle is in a range of 75° to 105°. The formed angle is preferably 80° to 100°, more preferably 85° to 95°, and most preferably 90°.

In one embodiment of the present disclosure, a modified surface including an end face modified region can be formed inside the transparent member by repeating the emitting and the scanning of the laser light as describe above while changing the focal depth of the laser light. By applying an external force to the transparent member along the modified surface, the transparent member can be cleaved.

In the method according to one embodiment of the present disclosure, an end surface modified region is formed at the end of the third surface of the transparent member. When the transparent member is cleaved along the modified surface, it is possible to significantly reduce the possibility that the end face side is cut at an unintended position. Therefore, in the method according to one embodiment, it is possible to cleave the transparent member with higher accuracy.

In particular, in the method according to one embodiment, even when the transparent member is thick, the transparent member can be cleaved with high accuracy.

In the present application, the “modified region” refers to a region of the transparent member modified by the laser light. Either voids, microcracks, or both are typically formed in the “modified region”. The term “modified portion” refers to a substantially linear modified part formed on the surface and inside of the transparent member along the propagation direction of laser light. Either voids, microcracks, or both are also typically formed in the “modified portion”.

A key difference between the “modified region” and the “modified portion” is that the “modified portion” has directionality extending along the propagation direction of laser light in the transparent member, whereas the “modified region” does not necessarily have such directionality. That is, the “modified portion” extends along the propagation direction of laser light in the transparent member. On the other hand, the “modified region” extends along the direction different from the propagation direction of laser light in the transparent member, and extends, for example, in a direction perpendicular to the propagation direction of laser light in the transparent member (for example, the scanning direction of laser light). In general, a plurality of “modified portions” are arranged in a predetermined direction, and a “modified region” extending in the predetermined direction is then formed.

The propagation direction of laser light can be determined by observing a laser trace generated inside the transparent member.

In one embodiment of the present disclosure, there is also provided a method of processing a transparent member, the transparent member having a first surface extending perpendicularly to a direction of laser light emission, and a first side surface and a second side surface that are connected to the first surface, wherein a reflection member is provided on the same side of the transparent member as the first side surface to face or contact thereto, the method including: (1) emitting laser light having a predetermined focal depth in a direction perpendicular to the first surface, and scanning the laser light in a direction parallel to the first surface, wherein the focal depth is set at a depth farther than the lower end of the second side surface from the first surface in the direction of laser light emission, and the laser light is reflected on the reflection member to enter the first side surface, wherein the emitting and the scanning are both performed at least twice with different focal depths, so that a first modified region is formed, in emitting and scanning of first laser light, from the first surface to the lower end of the second side surface in the direction of first laser light emission, and a second modified region is formed, in emitting and scanning of second laser light, from the first surface to the lower end of the second side surface in the direction of second laser light emission, and wherein the first modified region or the second modified region is formed in a region having up to 2 mm depth from the second side surface; and (2) processing the transparent member by applying an external force along a plane including the first modified region and the second modified region.

Such an embodiment is advantageous when, for example, a transparent member having a rectangular parallelepiped shape is cleaved.

In the present application, the term “parallel” used with respect to a direction of laser light emission includes not only a case where the direction of laser light emission and the surface to be irradiated are strictly parallel to each other but also a case where an angle formed between the direction of laser light emission and the surface to be irradiated is within ±15°. The angle is preferably within ±10°, more preferably within ±5°, and most preferably 0°.

In one embodiment of the present disclosure, there is also provided a method of processing a transparent member, the transparent member having a first surface extending perpendicularly to a direction of laser light emission, and a second surface and a third surface that are connected to the first surface, and the second surface being an inclined surface, the method including: (1) emitting laser light having a predetermined focal depth in a direction perpendicular to the first surface, and scanning the laser light in a direction parallel to the first surface, wherein the focal depth is set at a depth between the first surface and the lower end of the third surface in the direction of laser light emission, the laser light is reflected on the second surface, wherein the emitting and the scanning are both performed at least twice with different focal depths, so that a first modified region is formed, in emitting and scanning of first laser light, from the second surface to the third surface in a scanning direction of first laser light, and a second modified region is formed, in emitting and scanning of second laser light, in a region having up to 2 mm depth from the third surface from the first surface to the lower end of the third surface in the direction of second laser light emission; and (2) processing the transparent member by applying an external force along a plane including the first modified region and the second modified region.

Such an embodiment is advantageous when, for example, a prismatic transparent member having one or more of inclined surfaces is cleaved.

### Transparent Member to Which the Method According to One Embodiment of the Present Disclosure may be Applied

A transparent member used for the method according to one embodiment of the present disclosure is not particularly limited as long as it is transparent. For example, the transparent member may be a member having an absorption spectrum and a thickness such that at least a portion of laser light is transmitted in a linear absorption form. The transparent member may be made of, for example, glass.

Also, the transparent member may have any shape. The transparent member may have, for example, a plate shape, a block shape, or a rod shape.

The transparent member may have, for example, a rectangular parallelepiped shape or a prismatic shape (e.g., a triangular prism or a quadrangular prism).

The thickness of the transparent member is not particularly limited. The thickness may be, for example, greater than or equal to 1 mm, preferably greater than or equal to 2 mm, and more preferably greater than or equal to 5 mm. The thickness may be, for example, less than or equal to 19 mm. As described above, according to one embodiment of the present disclosure, even a “thick” transparent member can be cleaved at an appropriate position.

The “thickness” of the transparent member refers to the shortest dimension of the transparent member. For example, when the transparent member is a rectangular parallelepiped, the thickness represents the shortest dimension among the dimensions of length, width, and height. When the transparent member is a prism, the thickness is usually the minimum dimension of each side in a cross-section perpendicular to the stretching axis.

### Laser Light

Laser light used in the method according to one embodiment of the present disclosure is not particularly limited as long as a modified region can be formed inside a transparent member.

The laser light is, for example, a short-pulse laser having a pulse width in the femtosecond order to the nanosecond order, that is, 1.0 × 10⁻¹⁵ to 9.9 × 10⁻⁹ seconds. The short pulse laser is preferably a burst pulse laser. The average power of the short-pulse laser is, for example, 30 W or more.

The laser power of burst pulse laser light is about 90% of the rated power (50 W), the burst frequency is about 60 kHz, and the burst duration is 20 picoseconds to 165 nanoseconds. The time width of the burst is preferably in a range of 10 nanoseconds to 100 nanoseconds.

Scanning of laser light for one focal depth may be performed only once or a plurality of times.

An article obtained by processing a transparent member according to one embodiment of the present disclosure is, for example, an optical member.

### Method of Processing a Transparent Member According to One Embodiment of Present Disclosure

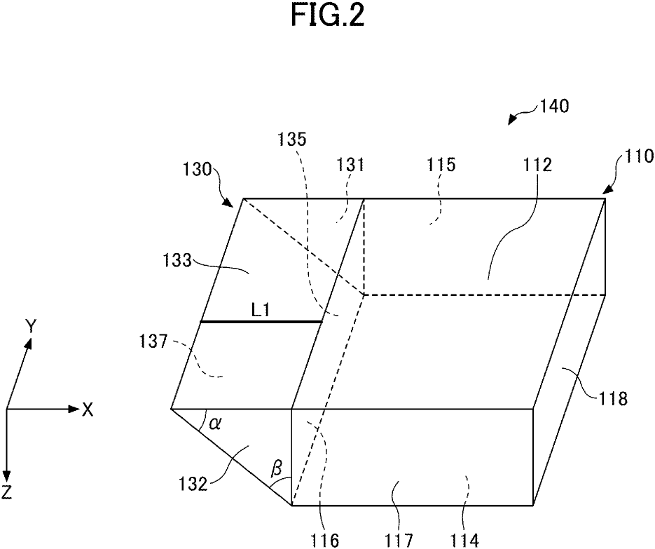

Hereinafter, a method of processing a transparent member according to one embodiment of the present disclosure will be described in more detail with reference to FIGS. 2 to 6.

FIG. 2 illustrates a schematic perspective view of a transparent member that may be used in the method according to one embodiment of the present disclosure.

As shown in FIG. 2, a transparent member 110 has a substantially rectangular parallelepiped shape. That is, the transparent member 110 has a first surface 112 and a second surface 114 opposite to each other, and four side surfaces 115, 116, 117 and 118. The side surfaces 115 and 117 are opposed to each other, and the side surfaces 116 and 118 are also opposed to each other. In particular, the side surfaces 116 and 118 are also referred to as the “first side surface 116” and the “second side surface 118”, respectively.

As shown in FIG. 2, an X direction, a Y direction, and a Z direction are defined with respect to the transparent member 110. According to this definition, the first surface 112 and the second surface 114 of the transparent member 110 are parallel to a X-Y plane, and the first side surface 116 and the second side surface 118 are parallel to a Y-Z plane.

A reflection member 130 disposed in contact with the transparent member 110 is also shown in FIG. 2.

The reflection member 130 has a substantially triangular prism shape, and includes a top surface 131, a lower surface 132, and three surfaces extending between the top surface 131 and the lower surface 132. The three surfaces are individually referred to as a first surface 133, a second surface 135, and an inclined surface 137. The first surface 133 and the second surface 135 are orthogonal to each other. On the other hand, the inclined surface 137 is inclined at an inclination angle α with respect to the first surface 133, and is inclined at an inclination angle β with respect to the second surface 135.

In the example of FIG. 2, the inclination angle α = β = 45°.

The inclined surface 137 of the reflection member 130 has a function of causing laser light to reflect.

The second surface 135 of the reflection member 130 has the same shape as the first side surface 116 of the transparent member 110.

The reflection member 130 is provided on the same side of the transparent member 110 as the first side surface 116. Specifically, the reflection member 130 is disposed in close contact with the transparent member 110 such that all sides of the second surface 135 of the reflection member 130 coincide with all sides of the first side surface 116 of the transparent member 110. The reflection member 130 is also disposed with respect to the transparent member 110 such that the first surface 133 of the reflection member 130 is flush with the first surface 112 of the transparent member 110.

However, the dimensions of the reflection member 130 and the placement relative to the transparent member 110 shown in FIG. 2 are merely exemplary. For example, the reflection member 130 may be disposed in a state where the second surface 135 is not in contact with the first side surface of the transparent member 110. In addition, the first surface 133 of the reflection member 130 need not be flush with the first surface 112 of the transparent member 110, and the boundary between the reflection member 130 and the transparent member 110 may have a level difference.

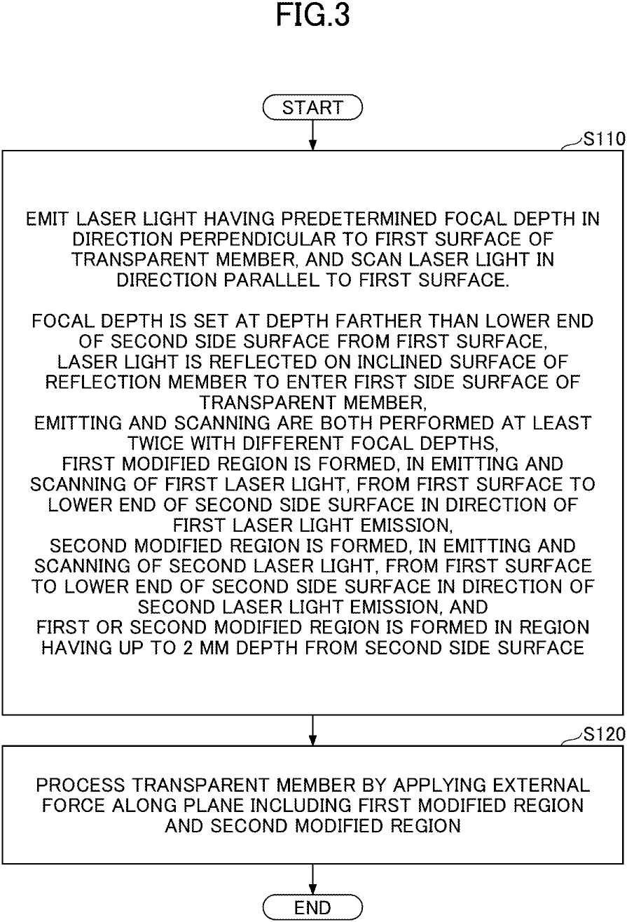

FIG. 3 schematically illustrates a flow of the method of processing the transparent member 110 shown in FIG. 2 (hereinafter referred to as a “first method”).

As shown in FIG. 3, the first method includes: (1) (Step S110) emitting laser light having a predetermined focal depth in a direction perpendicular to a first surface, and scanning the laser light in a direction parallel to the first surface, wherein the focal depth is set at a depth farther than a lower end of a second side surface from the first surface, and the laser light is reflected on an inclined surface of a reflection member to enter a first side surface of the transparent member, wherein the emitting and the scanning are both performed at least twice with different focal depths, so that a first modified region is formed, in emitting and scanning of first laser light, from the first surface to the lower end of the second side surface in the direction of first laser light emission, and a second modified region is formed, in emitting and scanning of second laser light, from the first surface to the lower end of the second side surface in the direction of second laser light emission, and wherein the first modified region or the second modified region is formed in a region having up to 2 mm depth from the second side surface; and (2) (Step S120) processing the transparent member by applying an external force along a plane including the first modified region and the second modified region.

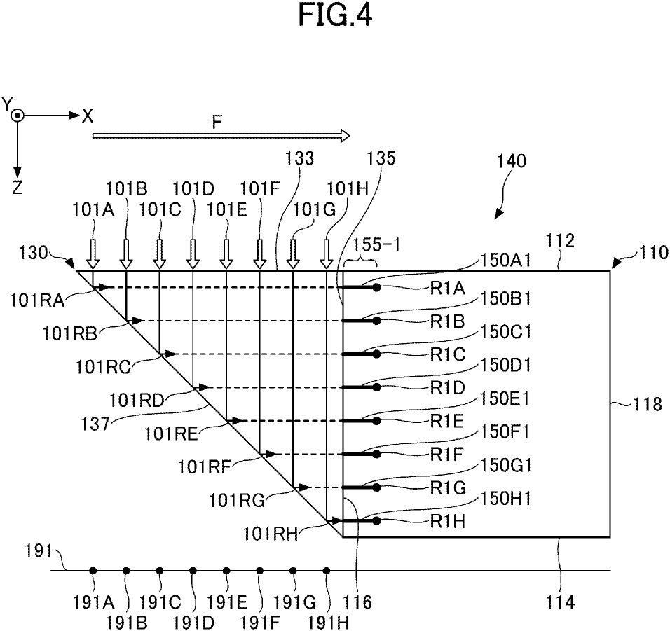

Hereinafter, each step will be described with reference to FIGS. 4 to 6.

### Step S110

First, the transparent member 110 and the reflection member 130 (hereinafter collectively referred to as an “assembly” 140) as shown in FIG. 2 described above are irradiated with laser light. Further, the laser light is scanned along the upper surface of the assembly 140.

FIG. 2 schematically illustrates an example of a scanning line L1 of laser light with respect to the assembly 140. In the example shown in FIG. 2, the scanning line L1 of laser light remains on the first surface 133 of the reflection member 130, and the laser light is not scanned on the first surface 112 of the transparent member 110.

The scanning line L1, however, may be further extended to scan the laser light so as to include the first surface 112 of the transparent member 110.

FIG. 4 schematically illustrates a cross-section of the assembly 140 taken along a cutting plane including the scanning line L1 shown in FIG. 2.

As shown in FIG. 4, the laser light is emitted perpendicularly to the first surface 133 of the reflection member 130 (i.e., the first surface 112 of the transparent member 110).

The laser light is scanned in the arrow F direction from left to right (positive direction of the X-axis) in FIG. 4. As described above, in this example, the laser light is not scanned over the first surface 112 of the transparent member 110.

When the assembly 140 is not present, the focal point of the laser light moves along the positive direction of the X-axis as the laser light is scanned. Hereinafter, a virtual path, including each of the focal points of laser light, that extends along with the scanning of laser light is referred to as a “focal line 191”.

The focal line 191 is set, in the direction of laser light emission (Z direction in FIG. 4), at a level lower than the lower end of the second side surface 118 of the transparent member 110, that is, a level farther than the second surface 114 from the first surface 112.

When the laser light is scanned in the arrow F direction, first laser light 101A vertically emitted to the assembly 140 shown on the leftmost side is reflected on the inclined surface 137 of the reflection member 130 becomes first reflected laser light 101RA, and propagates along the X direction.

Since the focal point of the first laser light 101A is set at a point 191A on the focal line 191, the first reflected laser light 101RA propagates in the X direction by a distance corresponding to the distance from the intersection between the first laser light 101A and the inclined surface 137 to the focal point 191A. As a result, the first reflected laser light 101RA propagates from the first side surface 116 of the transparent member 110 in contact with the second surface 135 of the reflection member 130 to the inside of the transparent member 110, and is focused at a point R1A therein.

A modified portion having a predetermined length including the point R1A is thereby formed along the X direction. In FIG. 4, the modified portion is schematically represented by a line 150A1 (modified portion 150A1).

Next, by scanning, second laser light 101B emitted on the right side of the first laser light 101A is reflected on the inclined surface 137, becomes second reflected laser light 101RB, and propagates along the X direction.

Since the focal point of the second laser light 101B is set at a point 191B on the focal line 191, the second reflected laser light 101RB propagates in the X direction by a distance corresponding to the distance from the intersection between the second laser light 101B and the inclined surface 137 to the focal point 191B. As a result, the second reflected laser light 101RB propagates inside the transparent member 110, and is focused at a point R1B therein.

Accordingly, a modified portion 150B1 having a predetermined length including the point R1B is formed along the X direction.

Similarly, modified portions 150C1 to 150H1 having a predetermined length are formed inside the transparent member 110 corresponding to third laser light 101C to eighth laser light 101H.

A first modified region 155-1 is then formed inside the transparent member 110 in the direction of laser light emission (Z direction), that is, from the first surface 112 to the second surface 114.

It is required be noted that the extending direction of the first modified region 155-1 is the Z direction, which is perpendicular to the extending direction of each of the modified portions 150A1 to 150H1 included in the first modified region 155-1 (the X direction).

The above-described Step S110 is then repeated with different focal depth.

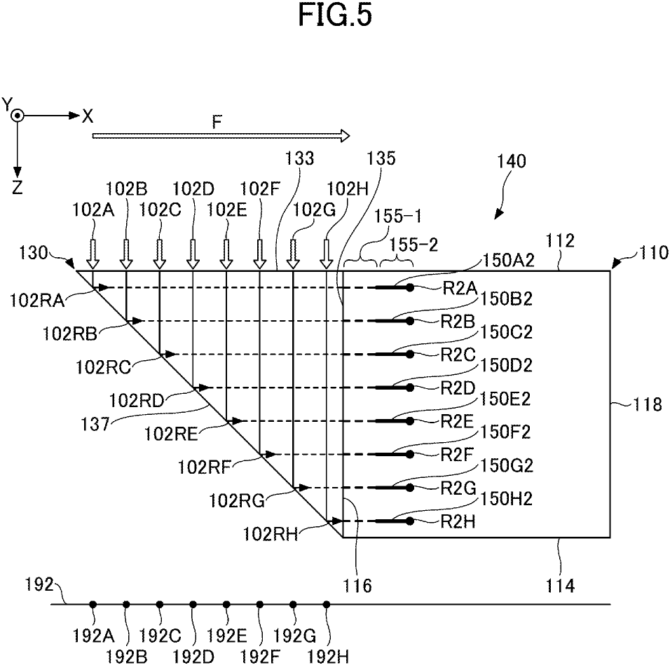

FIG. 5 schematically illustrates a cross-section of the assembly 140 similar to FIG. 4. However, in FIG. 5, laser light is adjusted such that the focal point path by the scanning when the assembly 140 is not present becomes a focal line 192 instead of the focal line 191. The focal line 192 is set at a level farther than the focal line 191 in the direction of laser light emission (Z direction in FIG. 5) from the first surface 133 of the reflection member 130, that is, from the first surface 112 of the transparent member 110.

Also, in this step, first laser light 102A vertically emitted to the first surface 133 of the reflection member 130 shown on the leftmost side is reflected on the inclined surface 137 of the reflection member 130 to become first reflected laser light 102RA, and propagates along the X direction.

Since the focal point of the first laser light 102A is set at a point 192A on the focal line 192, the first reflected laser light 102RA propagates in the X direction by a distance corresponding to the distance from the intersection between the first laser light 102A and the inclined surface 137 to the focal point 192A. As a result, the first reflected laser light 102RA propagates from the first side surface 116 of the transparent member 110 in contact with the second surface 135 of the reflection member 130 to the inside of the transparent member 110, and is focused at a point R2A therein.

A modified portion 150A2 having a predetermined length and the point R2A as a starting point is thereby formed along the X direction.

Next, by scanning, second laser light 102B emitted on the right side of the first laser light 102A is reflected on the inclined surface 137, becomes second reflected laser light 102RB, and propagates along the X direction.

Since the focal point of the second laser light 102B is set at a point 192B on the focal line 192, the second reflected laser light 102RB propagates in the X direction by a distance corresponding to the distance from the intersection between the second laser light 102B and the inclined surface 137 to the focal point 192B. As a result, the second reflected laser light 102RB propagates inside the transparent member 110, and is focused at a point R2B therein.

Accordingly, a modified portion 150B2 having a predetermined length including the point R2B is formed along the X direction.

Similarly, modified portions 150C2 to 150H2 having a predetermined length are formed inside the transparent member 110 corresponding to third laser light 102C to eighth laser light 102H.

A second modified region 155-2 along the Z direction is then formed inside the transparent member 110. The second modified region 155-2 may be integrated with the first modified region 155-1 formed by the previous scanning.

The same process is repeated with different focal depth, if necessary.

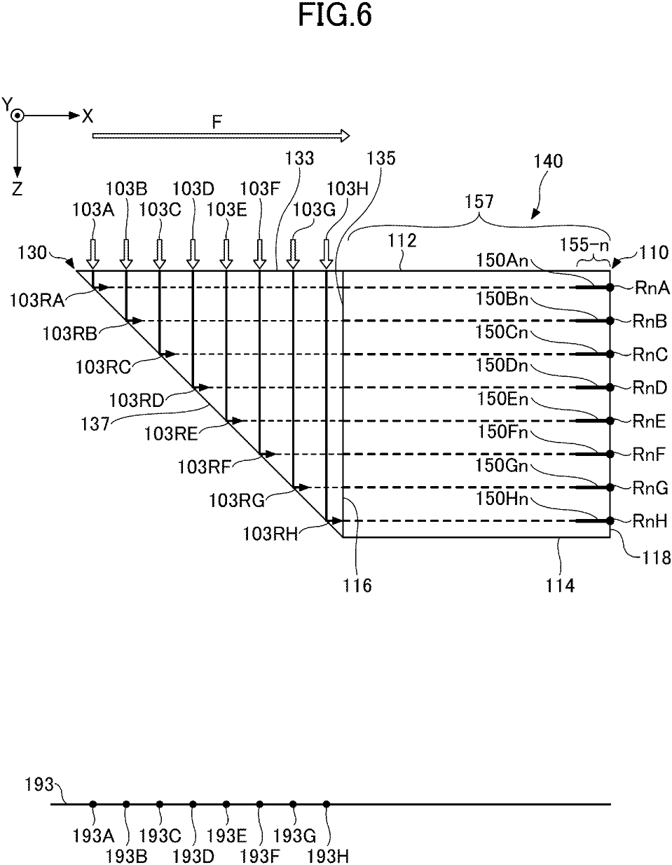

FIG. 6 schematically illustrates a cross-section of the assembly 140 similar to FIGS. 4 and 5. In FIG. 6, the path including the focal points of laser light is set to a focal line 193 which is farther than the focal lines 191 and 192 from the first surface 112 of the transparent member 110.

Also, in this case, first laser light 103A vertically emitted to the first surface 133 of the reflection member 130 shown on the leftmost side is reflected on the inclined surface 137 of the reflection member 130, becomes first reflected laser light 103RA, and propagates along the X direction.

Since the focal point of the first laser light 103A is set at a point 193A on the focal line 193, the first reflected laser light 103RA propagates in the X direction by a distance corresponding to the distance from the intersection between the first laser light 103A and the inclined surface 137 to the focal point 193A. As a result, the first reflected laser light 103RA is focused at a point RnA of the transparent member 110.

Accordingly, a modified portion 150An having a predetermined length including the point RnA is formed along the X direction.

Next, by scanning, second laser light 103B emitted on the right side of the first laser light 103A is reflected on the inclined surface 137, becomes second reflected laser light 103RB, and propagates along the X direction.

Since the focal point of the second laser light 103B is set at a point 193B on the focal line 193, the second reflected laser light 103RB propagates in the X direction by a distance corresponding to the distance from the intersection between the second laser light 103B and the inclined surface 137 to the focal point 193B. As a result, the second reflected laser light 103RB propagates inside the transparent member 110, and is focused at a point RnB therein.

Accordingly, a modified portion 150Bn having a predetermined length including the point RnB is formed along the X direction.

Similarly, modified portions 150Cn to 150Hn having a predetermined length are formed inside the transparent member 110 corresponding to third laser light 103C to eighth laser light 103H.

An n-th modified region 155-n along the Z direction is then formed inside the transparent member 110. In addition, a modified surface 157 including all of the modified regions previously formed is formed.

In Step S110, by performing the laser light scanning while changing the height level of the focal line as described above, an “end face modified region”, 155-n, is formed on the same side of the transparent member 110 as the second side surface 118.

In the first method, as required, the focal line of laser light may be adjusted so that the “end face modified region” is also formed on the same side of the transparent member 110 as the first side surface 116 (see FIG. 4).

When the “end face modified regions” are individually formed along the Z direction in the vicinity of the first side surface 116 and the vicinity of the second side surface 118 of the transparent member 110, the transparent member 110 can be cleaved with higher accuracy in the next Step S120.

### Step S120

The transparent member 110 is cleaved by applying an external force along the modified surface 157 formed by the step described above.

The method of cleaving is not particularly limited.

The transparent member 110 may be cleaved by, for example, locally heating or locally cooling the transparent member 110.

For example, a cleaving laser may be used to cleave the transparent member 110 by emitting laser light to the first surface 112 of the transparent member 110 and scanning the laser light along the modified surface 157 of the transparent member 110. Alternatively, laser light of the cleaving laser may be emitted to the second surface 114 of the transparent member 110.

Such a cleaving laser may be a CO₂ laser.

Through the above steps, the transparent member 110 can be cleaved.

In the first method, the modified surface 157 having the end face modified region 155-n formed on the second side surface 118 of the transparent member 110 is formed.

When the transparent member 110 is cleaved along the modified surface 157, the possibility that the end surface side such as the second side surface 118 is cut at an unintended position can be significantly reduced.

In the first method, a characteristic cut-face having a plurality of laser processing marks extending along the propagation direction of reflected laser light (the X direction in FIGS. 4 to 6) is obtained.

As indicated by the scanning line L1 in FIG. 2, in the first method, the laser light is scanned only in the region of the reflection member 130, and not on the first surface 112 of the transparent member 110.

However, when the laser light is emitted and scanned from above the first surface 112 of the transparent member 110 such that the focal position of the laser light is located inside the transparent member 110 as in the related art, a modified portion extending in the Z direction can be formed inside the transparent member 110. Thereby, a cut-face having laser processing marks extending vertically and horizontally in a grid pattern is obtained, in this case.

The method of processing the transparent member 110 having a substantially rectangular parallelepiped shape using the first method has been described above.

The above description is, however, merely an example, and a part of the first method may be changed.

For example, in the above description, as illustrated in FIGS. 4 to 6, the modified regions (155-1, 155-2, and 155-n) is sequentially formed from the first side surface 116 toward the second side surface 118 of the transparent member 110. However, the order of forming the modified regions is not particularly limited. For example, the modified region (the end face modified region 155-n) may be first formed on the second side surface 118, and then the modified regions may be sequentially formed toward the first side surface 116. Alternatively, each of the modified regions may be formed in another order.

In the above description, the reflection member 130 of the substantially triangular prism shape having the inclined surface 137 is disposed beside the transparent member 110.

However, instead of the reflection member 130 having such a three-dimensional shape, a planar reflection member such as a mirror may be used. In this case, the reflection member is disposed so as to constitute only the inclined surface 137 of the reflection member 130 shown in FIG. 2.

That is, in the first method, it is required to be noted that the configuration of the reflection member is not particularly limited if the inclined surface is configured to face the first side surface 116 of the transparent member 110 (including the case where the inclined surface faces the first side surface 116 in a non-parallel manner).

### Method of Processing a Transparent Member According to Another Embodiment of the Disclosure

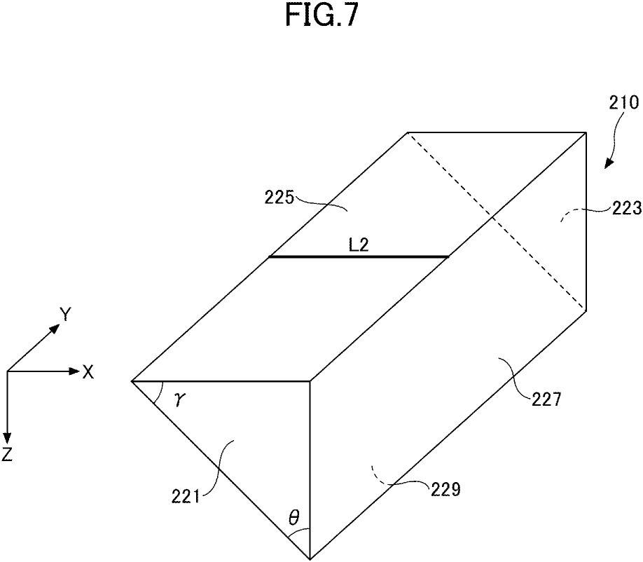

Hereinafter, a method of processing a transparent member according to another embodiment of the present disclosure will be described with reference to FIGS. 7 to 12.

FIG. 7 illustrates a schematic perspective view of a transparent member that may be used in a method according to the another embodiment of the present disclosure.

As shown in FIG. 7, a transparent member 210 has a substantially triangular prism shape. That is, the transparent member 210 has an upper surface 221 and a lower surface 223 opposite to each other, and three side surfaces 225, 227, and 229.

Hereinafter, the side surfaces 225, 227, and 229 are also particularly referred to as a “first surface 225”, a “second side surface 227”, and an “inclined surface 229”, respectively.

The upper surface 221 and the lower surface 223 are mutually congruent right triangles. That is, the first surface 225 and the second side surface 227 are orthogonal to each other, and the inclined surface 229 is inclined at an inclination angle γ with respect to the first surface 225 and is inclined at an inclination angle θ with respect to the second side surface 227.

In the example of FIG. 7, since the upper surface 221 and the lower surface 223 are right-angled isosceles triangles, the inclination angle γ = θ = 45°.

An X direction, a Y direction, and a Z direction are defined with respect to the transparent member 210, as shown in FIG. 7. According to this definition, the upper surface 221 and the lower surface 223 of the transparent member 210 are parallel to the X-Z plane, the first surface 225 is parallel to the X-Y plane, and the second side surface 227 is parallel to the Y-Z plane.

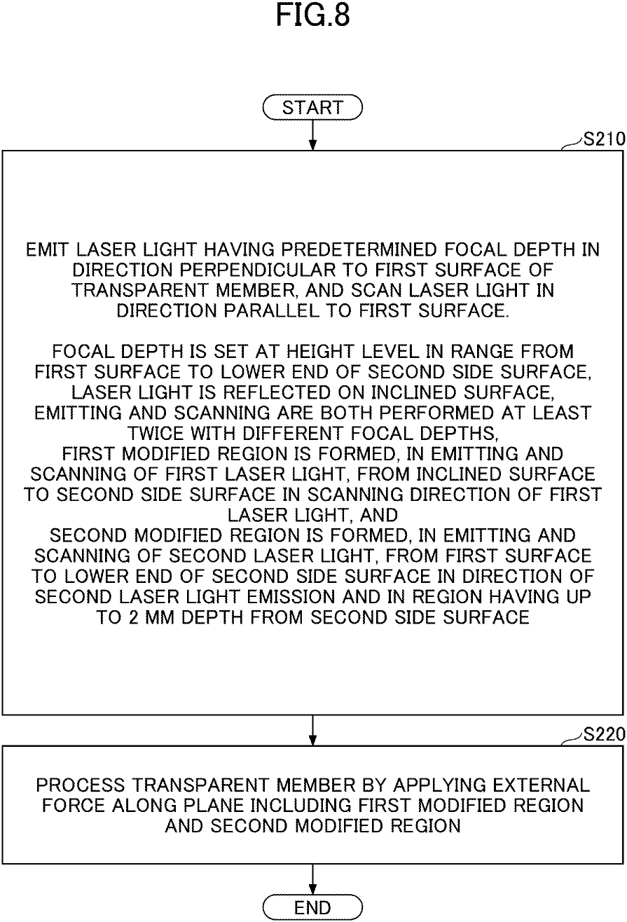

FIG. 8 schematically illustrates a flow of the method (hereinafter referred to as a “second method”) for processing the transparent member 210 shown in FIG. 7.

As shown in FIG. 8, the second method includes: (Step S210) emitting laser light having a predetermined focal depth in a direction perpendicular to a first surface of a transparent member, and scanning the laser light in a direction parallel to the first surface, wherein the focal depth is set at a height level in a range from the first surface to a lower end of a second side surface, and the laser light is reflected on an inclined surface, wherein the emitting and the scanning are both performed at least twice with different focal depths, so that a first modified region is formed, in emitting and scanning of first laser light, from the inclined surface to the second side surface in a scanning direction of first laser light, and a second modified region is formed, in emitting and scanning of second laser light, from the first surface to a lower end of the second side surface in the direction of second laser light emission and in a region having up to 2 mm depth from the second side surface; and (Step S220) processing the transparent member by applying an external force along a plane including the first modified region and the second modified region

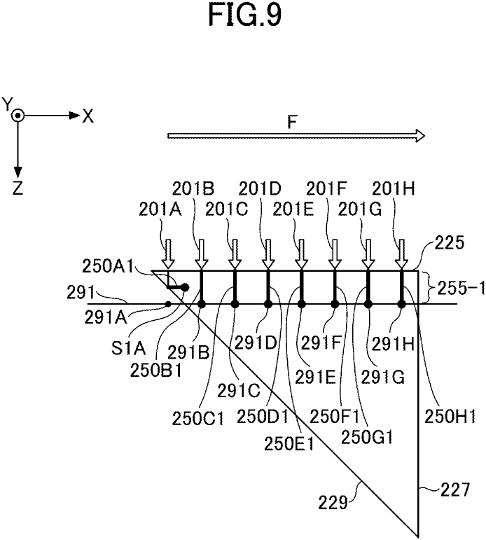

Hereinafter, each step will be described with reference to FIGS. 9 to 12.

### Step S210

First, the transparent member 210 as shown in FIG. 7 is irradiated with laser light, and the laser light is scanned.

FIG. 7 schematically illustrates an example of a scanning line L2 of the laser light with respect to the transparent member 210.

FIG. 9 schematically illustrates a cross-section of the transparent member 210 taken along a cutting plane including the scanning line L2 shown in FIG. 7.

As shown in FIG. 9, the laser light is emitted perpendicularly to the first surface 225 of the transparent member 210.

The laser light is then scanned in an arrow F direction from left to right (the positive direction of the X-axis) in FIG. 9.

When the transparent member 210 is not present, the focal point of the laser light moves along the positive direction of the X-axis as the laser light is scanned. Hereinafter, a virtual path, including each of the focal points of laser light, that extends along with the scanning of laser light is referred to as a “focal line 291”.

The focal line 291 is set in a range from the first surface 225 to the lower end of the second side surface 227 of the transparent member 210 in the direction of laser light emission (Z direction in FIG. 9).

Here, when the laser light is scanned in the arrow F direction, first laser light 201A, shown on the leftmost side in FIG. 9, emitted perpendicularly to the first surface 225 of the transparent member 210, is reflected on the inclined surface 229, becomes first reflected laser light, and propagates along the X direction.

Since the focal point of the first laser light 201A is set at a focal point 291A on the focal line 291, the first reflected laser light propagates in the X direction by a distance corresponding to the distance from the intersection point between the first laser light 201A and the inclined surface 229 to the focal point 291A. As a result, the first reflected laser light is focused at a point S1A inside the transparent member 210.

Thereby, a modified portion having a predetermined length including the point S1A is formed along the X direction. In FIG. 9, this modified portion is schematically represented by a line 250A1.

Next, by scanning, second laser light 201B emitted on the right side of the first laser light 201A does not reach the inclined surface 229 since the distance from the first surface 225 to a focal point 291B is shorter than the distance to the inclined surface 229. The second laser light 201B therefore forms a modified portion 250B1 having a predetermined length including the focal point 291B inside the transparent member 210. Unlike the modified portion 250A1, the modified portion 250B1 extends in the Z direction.

Similarly, in correspondence with third laser light 201C to eighth laser light 201H, modified portions 250C1 to 250H1 having a predetermined length are formed inside the transparent member 210 along the Z direction.

A first modified region 255-1 along the X direction is then formed inside the transparent member 210.

Next, the scanning described above is repeated with different focal depth.

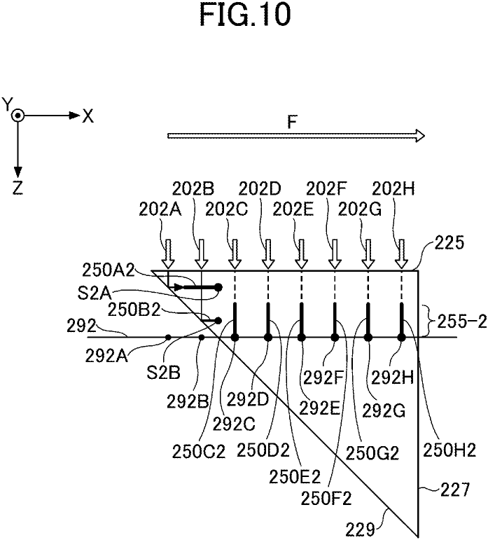

FIG. 10 schematically illustrates a cross-section of the transparent member 210 similar to that of FIG. 9. However, in FIG. 10, laser light is adjusted such that the focal point path by the scanning becomes a focal line 292 instead of the focal line 291. The focal line 292 is set at a level farther than the focal line 291 from the first surface 225 in the direction of laser light emission (Z direction in FIG. 10).

The focal line 292 is, however, still set at a height between the first surface 225 and the lower end of the second side surface 227.

Also, in this scanning, first laser light 202A vertically emitted to the first surface 225 of the transparent member 210 shown on the leftmost side is reflected on the inclined surface 229 of the transparent member 210 to become a first reflected laser light, and propagates along the X direction.

Since the focal point of the first laser light 202A is set at a point 292A on the focal line 292, the first reflected laser light propagates in the X direction by a distance corresponding to the distance from the intersection point between the first laser light 202A and the inclined surface 229 to the focal point 292A. As a result, the first reflected laser light is focused at a point S2A inside the transparent member 210.

Accordingly, a modified portion 250A2 having a predetermined length including the point S2A is formed along the X direction.

Next, by scanning, second laser light 202B emitted on the right side of the first laser light 202A is reflected on the inclined surface 229, becomes second reflected laser light, and propagates along the X direction.

Since the focal point of the second laser light 202B is set a point 292B on the focal line 292, the second reflected laser light propagates in the X direction by a distance corresponding to the distance from the intersection between the second laser light 202B and the inclined surface 229 to the focal point 292B. As a result, the second reflected laser light is focused at a point S2B inside the transparent member 210.

Accordingly, a modified portion 250B2 having a predetermined length including the point S2B is formed along the X direction.

On the other hand, by scanning, third laser light 202C emitted on the right side of the second laser light 202B does not reach the inclined surface 229 since the distance from the first surface 225 to a focal point 292C is shorter than the distance to the inclined surface 229.

The third laser light 202C therefore forms a modified portion 250C2 having a predetermined length including the focal point 292C inside the transparent member 210. Unlike the modified portions 250A2 and 250B2, the modified portion 250C2 extends in the Z direction.

Similarly, modified portions 250D2 to 250H2 having a predetermined length are formed inside the transparent member 210 corresponding to fourth laser light 202D to eighth laser light 202H.

A second modified region 255-2 along the X direction is then formed inside the transparent member 210. The second modified region 255-2 may be integrated with the first modified region 255-1 previously formed.

In this step, in addition to the second modified region 255-2 extending in the X direction, the modified portion 250A2 extending in the X direction is formed in the first modified region 255-1.

The same process is repeated with a different focal depth, if necessary.

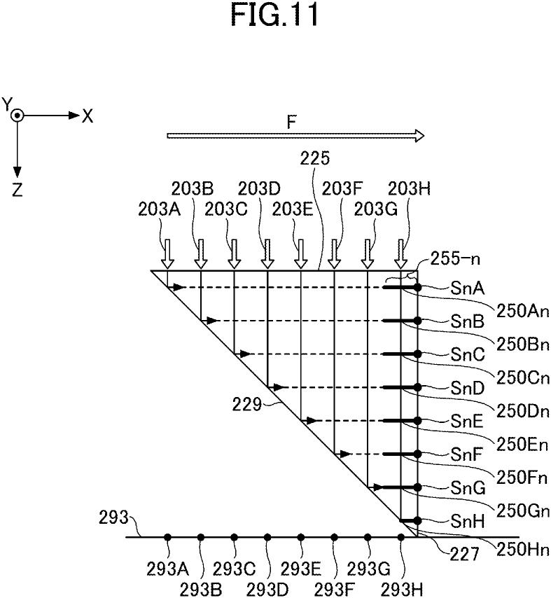

FIG. 11 schematically illustrates a cross-section of the transparent member 210 similar to FIGS. 9 and 10. In in FIG. 11, the focal point path of the laser light is set, however, to a focal line 293 which is farther than the focal lines 291 and 292 from the first surface 225.

Also, in this case, first laser light 203A, shown on the leftmost side, vertically emitted to the first surface 225 of the transparent member 210 is reflected on the inclined surface 229 of the transparent member 210 to become first reflected laser light, and propagates along the X direction.

Since the focal point of the first laser light 203A is set at a point 293A on the focal line 293, the first reflected laser light propagates in the X direction by a distance corresponding to the distance from the intersection between the first laser light 203A and the inclined surface 229 to the focal point 293A. As a result, the first reflected laser light is focused at a point SnA inside the transparent member 210.

A modified portion 250An having a predetermined length including the point SnA is formed along the X direction.

Next, by scanning, second laser light 203B emitted on the right side of the first laser light 203A is reflected on the inclined surface 229, becomes second reflected laser light, and propagates along the X direction.

Since the focal point of the second laser light 203B is set at a point 293B on the focal line 293, the second reflected laser light propagates in the X direction by a distance corresponding to the distance from the intersection between the second laser light 203B and the inclined surface 229 to the focal point 293B. As a result, the second reflected laser light is focused at a point SnB inside the transparent member 210.

A modified portion 250Bn having a predetermined length including the point SnB is formed along the X direction.

Similarly, modified portions 250Cn to 250Hn having a predetermined length extending in the X direction are formed inside the transparent member 210 in correspondence with third laser light 203C to eighth laser light 203H.

As a result, an end face modified region 255-n can be formed on the second side surface 227 of the transparent member 210 from the first surface 225 to the lower end of the second side surface 227 in the direction of laser light emission (Z direction).

If necessary, the end face modified region may also be formed in the vicinity of the inclined surface 229 of the transparent member 210, to be specific, in a region having up to 2 mm depth from the surface of inclined surface 229.

By performing such a step, a plurality of modified regions along the X direction and the Z direction are formed inside the transparent member 210. Further, a modified surface is formed so as to include the formed modified regions.

FIG. 12 schematically illustrates an example of an aspect of modified portions inside the transparent member 210 obtained after performing a plurality of laser light scanning while changing the focal line level.

As shown in FIG. 12, the modified regions along the X direction and the Z direction are formed inside the transparent member 210 by performing a plurality of laser light scanning while changing the focal line level, and further, a modified surface 257 can be formed over the entire X-Z plane.

### Step S220

Next, the transparent member 210 is cleaved by applying an external force along the modified surface 257 formed by the step described above.

The method of cleaving is not particularly limited, and the above first method may be employed.

Through the step described above, the transparent member 210 can be cleaved along a predetermined cutting plane.

In the second method, the modified surface 257 having the end face modified region 255-n is formed on the second side surface 227 of the transparent member 210.

Therefore, when the transparent member 210 is cleaved along the modified surface 257, the possibility that the end surface side such as the second side surface 227 is cut at an unintended position can be significantly reduced.

According to the second method, a characteristic cut-face is obtained in which processing marks formed by laser processing extend in two directions. For example, as shown in FIG. 12, it is possible to form a cut-face in which processing marks by laser processing extend in a vertical and horizontal grid shape.

The method of processing the transparent member 210 having a substantially triangular prism shape using the second method has been described above.

The above description is, however, merely an example, and a part of the second method may be changed.

For example, in the above description, as shown in FIGS. 9 to 11, after the various modified regions (255-1, 255-2) are formed, the end face modified region 255-n is finally formed. However, the order in which the end face modified region 255-n is formed is not particularly limited. For example, the end face modified region 255-n may be formed first, and then, the other modified regions (255-1 and 255-2) may be formed. Alternatively, the end face modified region 255-n may be formed in another order.

In the above description, the substantially triangular prism-shaped transparent member 210 having the inclined surface 229 is used, and the laser light is reflected using the inclined surface 229. However, a planar reflection member may be attached to the inclined surface 229 of the transparent member 210 instead.

In the example shown in FIG. 7, an angle γ between the inclined surface 229 and the first surface 225 is 45°, and an angle θ between the inclined surface 229 and the second side surface 227 is 45°. However, angles other than 45° may be used for γ and θ.

Further, various changes can be made.

### EXAMPLE

An example of the present disclosure will be described below.

The method according to the another embodiment of the present disclosure was employed to process a transparent member.

A glass member was used as the transparent member, and processed using the second method described above. The glass member was a triangular prism, and the shapes of the upper surface and the lower surface of the triangular prism were right-angled isosceles triangles.

As shown in FIG. 7 described above, the glass member was fixed on a mounting table such that an inclined surface of the glass member was oriented at 45° with respect to the vertical direction and a plane to be subjected to laser light scanning (first surface 225) was directed upward. Laser light was emitted to the plane of the glass member thus arranged vertically from above, and scanned in a direction perpendicular to a stretching direction of the glass member, along the scanning line L2 shown in FIG. 7.

An ultra-short pulse laser light having a wave length of 1,064 nm was used for the laser light in this example. The pulse width of the laser light is 10 picoseconds, the pulse frequency of the burst is 75 kHz, and the power is 90% of the rating (50 W). The interval between the centers of the spots on the scanning line L2 was set 5 µm.

First, a focal depth of laser light was set as the height of the lower end of a second side surface, and first laser light scanning was performed (a first run). The focal depth of laser light was made 0.5 mm shorter than that in the first run, and second laser light scanning was performed (a second run). Thereafter, the focal depth was decreased by 0.5 mm each time, and the same laser light scanning was repeated. The last laser light scanning was performed with the focal depth of laser light as the height of the first surface of the glass member.

In each run, the laser light was scanned once.

After the last laser light scanning was performed, the glass member was subjected to a cleaving treatment.

A CO₂ laser having a wave length of 10.6 µm was used for the cleaving treatment. The CO₂ laser light was scanned along the aforementioned scanning line L2. The scanning speed was 40 mm/s.

After scanning of CO₂ laser light, the glass member was cleaved.

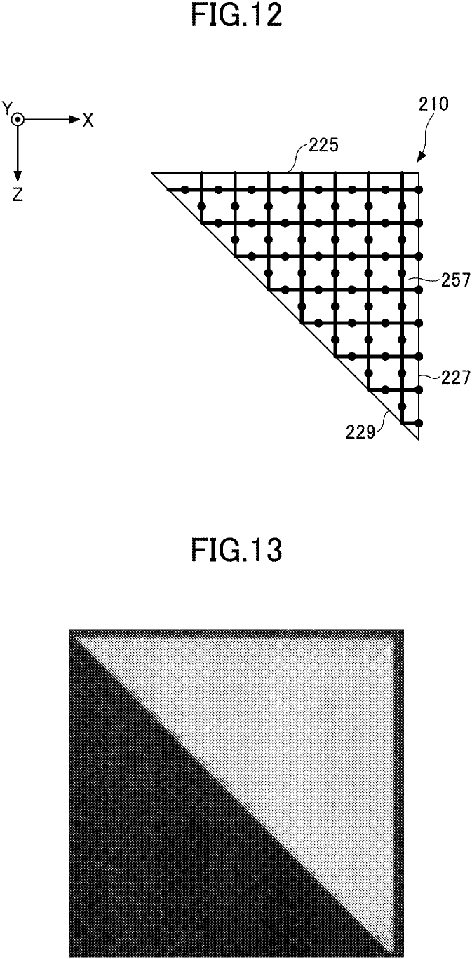

FIG. 13 shows an example of the cut-face of the glass member.

As shown in FIG. 13, the cut-face was in a smooth state over the entire surface, and no unevenness or step was observed even at the end portion.

As shown in FIG. 13, a grid pattern in which laser marks extended vertically and horizontally was observed in the cut-face.

As described above, by using the method according to one embodiment of the present disclosure, it was confirmed that a transparent member can be accurately cleaved at a desired position.

What is claimed is:

1. A method of processing a transparent member, the transparent member having a first surface extending perpendicularly to a direction of laser light emission, and a second surface and a third surface that are connected to the first surface, the method comprising emitting laser light in a direction perpendicular to the first surface, and scanning the laser light in a direction parallel to the first surface, wherein
the second surface of the transparent member is an inclined surface, or an inclined surface is disposed on a same side of the transparent member as the second surface, and
by causing the laser light to reflect on the inclined surface toward the third surface of the transparent member, a modified region is formed in a region having up to 2 mm depth from the third surface of the transparent member, from the first surface to a lower end of the third surface in the direction of laser light emission.

2. A method of processing a transparent member, the transparent member having a first surface extending perpendicularly to a direction of laser light emission, and a first side surface and a second side surface that are connected to the first surface, wherein a reflection member is provided on a same side of the transparent member as the first side surface to face or contact thereto, the method including:
(1) emitting laser light having a predetermined focal depth in a direction perpendicular to the first surface, and scanning the laser light in a direction parallel to the first surface,
wherein the focal depth is set at a depth farther than a lower end of the second side surface from the first surface in the direction of laser light emission, and the laser light is reflected on the reflection member to enter the first side surface,
wherein the emitting and the scanning are both performed at least twice with different focal depths,
so that a first modified region is formed, in emitting and scanning of first laser light, from the first surface to the lower end of the second side surface in a direction of first laser light emission, and a second modified region is formed, in emitting and scanning of second laser light, from the first surface to the lower end of the second side surface in a direction of second laser light emission, and
wherein the first modified region or the second modified region is formed in a region having up to 2 mm depth from the second side surface; and
(2) processing the transparent member by applying an external force along a plane including the first modified region and the second modified region.

3. The method according to claim 2, wherein the reflection member has an inclined surface, and the laser light is reflected on the inclined surface.

4. The method according to claim 2, wherein either the first modified region, the second modified region, or both include a plurality of modified portions extending in the direction parallel to the first surface, and arranged at different depths from the first surface over an entire depth range.

5. A method of processing a transparent member, the transparent member having a first surface extending perpendicularly to a direction of laser light emission, and a second surface and a third surface that are connected to the first surface, and the second surface being an inclined surface, the method including:
(1) emitting laser light having a predetermined focal depth in a direction perpendicular to the first surface, and scanning the laser light in a direction parallel to the first surface,
wherein the focal depth is set at a depth between the first surface and a lower end of the third surface in the direction of laser light emission, and the laser light is reflected on the second surface,
wherein the emitting and the scanning are both performed at least twice with different focal depths,
so that a first modified region is formed, in emitting and scanning of first laser light, from the second surface to the third surface in a scanning direction of first laser light, and
a second modified region is formed, in emitting and scanning of second laser light, in a region having up to 2 mm depth from the third surface, from the first surface to the lower end of the third surface in a direction of second laser light emission; and
(2) processing the transparent member by applying an external force along a plane including the first modified region and the second modified region.

6. The method according to claim 4, further comprising forming, after (1) :
a plurality of modified portions extending in the direction parallel to the first surface, and arranged at different depths from the first surface over an entire depth range; and
a plurality of modified portions extending in the direction perpendicular to the first surface, along the direction parallel to the first surface.

7. The method according to claim 5, wherein a cut-face having a grid of laser marks is produced.

8. The method according to claim 2, wherein the processing the transparent member by applying an external force includes emitting another laser light to the first surface of the transparent member, a surface opposite to the first surface, or at least one surface connected to the first surface.

9. The method according to claim 1, wherein a distance from the first surface to the lower end is greater than or equal to a 1 mm.
